(19) United States
(12) Patent Application Publication
(10) Pub. No.: US 2002/0030811 A1
(43) Pub. Date: Mar. 14, 2002

(54) Arrangement for visualizing molecules

(76) Inventor: Hansgeorg Schindler, Linz (AT)

Correspondence Address: Mark B. Wilson, Fulbright & Jaworski L.L.P., 600 Congress Avenue, Suite 2400, Austin, TX, 78701, US

(21) Appl. No.: 09/845,006

(22) Filed: Apr. 27, 2001

Related U.S. Application Data
(63) Continuation of application No. PCT/AT99/00257, filed on Oct. 28, 1999.

(30) Foreign Application Priority Data
Oct. 28, 1998 (AT) A 1799/98

(51) Int. Cl. G01N 21/64

(52) U.S. Cl. 356/318; 250/458.1; 422/82.08

(57) ABSTRACT

An arrangement for visualizing molecules, movements thereof, and interactions between molecules, and molecular processes in a sample, in particular molecules and processes in biological cells, by using the single dye tracing (SDT) method is described, comprising

at least one source of light for large-area fluorescence excitation via single or multi-photon absorption by equal or different marker molecules on molecules in the sample,

a sample holding means for accommodating the sample,

a highly-sensitive detection and analysis system comprising a charged coupled device (CCD) camera, the sample or the sample holding means, respectively, and/or the detection and analysis system being shiftable relative to each other during the measuring process, and

a control unit for coordinating and synchronizing illumination times and, optionally, wave lengths of the lateral or vertical movement of the sample or of the sample holding means, respectively, with the sample as well as, optionally, the positioning and shifting of the images of each sample position of the pixel array of the CCD camera.

The invention relates to a method for visualizing molecules, interactions between molecules and molecular processes in a sample by using the single dye labeling method, as well as arrangements for carrying out such methods.

The object of highly sensitive detection systems is the observation on the level of individual atoms or molecules, respectively. This has first been made possible by the invention of the “Scanning Probe”-microscopy methods (EP 0 027 517-B1; Binnig et al., Phys. Rev. Lett. 56 (1986), pp. 930-933; Drake et al., Science 243 (1989), pp. 1586-1589). Yet, the detection of single molecules has also been made possible by optical methods. The effective conversion of light by fluorescent molecules also allowed for the detection of individual fluorophores in liquids by confocal fluorescence microscopy as well as for effecting a high resolution spectroscopy of single dye molecules at low temperatures.

The first real imaging of single dye molecules by optical means was achieved by near field optical scanning microscopy (Betzig et al., Science 262 (1993), 1422-1425). With this method, a spatial resolution of about 14 nm was achieved, which is far below the optical diffraction limit, yet application of this method is limited to immobile objects.

Furthermore, it has been possible to image single fluorescence-labeled myosin molecules on immobilized actin filaments by conventional microscopy and illumination times of seconds (Funatsu et al., Nature 374 (1995), pp. 555-559). This method is limited to observations in the immediate proximity of the substrate surface (distance of up to about 100 nm).

In GB 2 231 958, the characterization of the fluorescence of solid specimens by time resolved fluorescence spectroscopy is described. In doing so, not even the single molecule sensitivity is achieved so that a detection of single fluorophores is not described. In this instance, the fluorescence is fixed in the specimen and immobile. Analyzed areas in the specimen are not subjected to microscopy, but scanned by a focus in the scanning method.

In principle, the method described in U.S. Pat. No. 5,528,046 is suitable for detecting single fluorophores, yet only if they have been fixed in clusters on surfaces. This measurement in the dry state (not in the aqueous phase) is, of course, not suitable for biological preparations because the functional and structural integrity of the biological preparations is destroyed by the process of drying. The apparatus constituting a prerequisite for the method described in U.S. Pat. No. 5,528,046 thus is not suitable for observing single molecules in biological samples. Moreover, also a shifting of the sample which is coupled with the detection and analysis arrangement, is not provided. Accordingly, with the methodology used there, in principle it is not possible to provide an image of biomolecules which must take place within a few milliseconds (50 milliseconds at the most), since with the device described in U.S. Pat. No. 5,528,046, the illumination time is around 60 seconds.

According to U.S. Pat. No. 4,793,705 it is, as such, maintained that individual particles or molecules can be identified, yet in fact this method proved to be impossible to be carried out, since individual fluorescence molecules could not be detected clearly and much less could be imaged. The ratio of signal to background of the individual observation being approximately 0.2 was extremely low so that fluctuation of the background was approximately of equal size as the signal. Also by the consecutive repetitions of the observation as well as by the parallel collection by two detectors this is not changed, either. Thus, also this method is not applicable to single molecule detection in solution or in biological systems. The method is not an imaging microscopy, but merely accumulates spatial information in sequence. Moreover, the control of a relative movement by the detection and analysis device is missing.

Single molecule detection by means of fluorescence spectroscopy in large volumes are described in DE 197 18 016 A and U.S. Pat. No. 5,815,262 A, as well as sequential fluorophore detection in the confocal scanning method (WO 97/43611). Yet also with these systems, the spatial microscopy and the temporal observation of single molecule movements, particularly in biological systems (e.g. in cells) are not possible.

For allowing biological systems to be analyzed in their complete extent and for their natural function and for their physiological mode of action, visualization of individual fluorophores in complex systems and in movement as simultaneously as possible is required, i.e. real imaging microscopy (no scanning of a focus) with single molecule sensitivity, without restriction to the immediate vicinity to the sample surface or to the substrate surface. So far, the movement of single dye molecules has merely been illustrated for fluorescence-labeled lipids in an artificial lipid membrane system (Schmidt et al., PNAS 93 (1996), pp. 2926-2929). The methodology used for this has generally been termed “single dye tracing” (SDT) method, since with this it is possible to trace the path of a single fluorescence-labeled molecule and of several ones simultaneously exactly and (as a single molecule) stoichiometrically without requiring an interaction (amplification) with other components (e.g. by binding, spatial close relationship etc.) for signal emission.

Mapping of the positions and tracing of the movements of single dye labeled molecules in cellular systems which would be required for a study of molecules or interactions between molecules in live systems is, however, not possible with the methods described. On the one hand, this is due to the fact that, in contrast to flat (planar) artificial lipid membranes, live cells are three-dimensional so that molecular movements in general do not occur in an optical image plane, and, on the other hand, to the fact that cells always have a certain autofluorescence which may interfere with the fluorescence microscopy-visualizing procedure proper. Moreoever, it has been considered impossible so far to analyze a plurality of such cellular systems with a suitable detection and analyzing method so rapidly that both the resolution in the single-molecular range is maintained and also molecular movements of the molecules to be detected can be observed.

Primarily the pharmaceutical industry is more and more interested in methods with which a high throughput screening (HTS) of a large number of possible test molecules is possible. Particularly for HTS methods, however, the hitherto described methods for SDT are not suitable.

Thus, the object of the present invention consists in modifying the SDT method such that screening, in particular HTS, is made feasible therewith.

Moreover, an SDT method is to be provided by which molecular processes of one or several different type(s) of molecules, preferably also in cellular systems, can be pursued in their real space-time dimension, wherein information on colocalization of molecules as well as on the stoichiometry of molecular associates and conformations of the molecules are also to be obtained.

Moreover, an arrangement and a method are to be provided, by means of which the imaging of fluorescence-labeled molecules in their distribution over entire biological systems, in particular cells, is made possible. Furthermore, imaging of consequences of molecular movements and processes is to be made feasible so that a three-dimensional image, with time resolution, of complex biological systems, such as cells, is made possible.

According to the invention, this object is achieved by an arrangement for visualizing molecules, their movements, and interactions between molecules, and molecular processes in a sample, in particular molecules and processes in biological cells, by using the single dye tracing (SDT) method, comprising

at least one source of light for large-area fluorescence excitation via single or multi-photon absorption by equal or different marker molecules on molecules in the sample,

a sample holding means for accommodating the sample,

a highly-sensitive detection and analysis system comprising a charged coupled device (CCD) camera, the sample or the sample holding means, respectively, and/or the detection and analysis system being shift-able relative to each other during the measuring process, and

a control unit for coordinating and synchronizing illumination times and, optionally, wave lengths, lateral or vertical movement of the sample or of the sample holding means, respectively, with the sample, as well as, optionally, the positioning and shifting of the images of each sample position of the pixel array of the CCD camera.

Due to the large-area fluorescence excitation, preferably 100 to 10,000 μm², depending on the application, imaging of the excited molecules in a large region may be very rapid and may be read into the pixel array of the CCD camera. In doing so, only the source of light needs to be suitable for large-area fluorescence excitation. Here, a preferred source of light is a laser. Preferably an argon laser, a dye laser and/or a two-photon fluorescence excitation laser is used, with acousto-optical switching between these sources of light and for temporal sequence of the illumination.

The CCD camera to be used according to the invention preferably comprises a frame shift mode and a continuous readout mode.

According to the invention, preferably a CCD camera is used which comprises one or several of the following properties: it is N₂-cooled; it has a large pixel array, in particular a pixel array ≧1340×1300 pixels; it is capable of making a conversion from photons into electrons of 0.8 to 0.9 in the optical range; it has a readout noise of merely a few electrons per pixel, preferably of merely 0 to 10, in particular 3 to 7, electrons per pixel, at 1 μs/pixel readout rate; and/or it has a lineshift rate of >3×10⁵/s.

With the arrangement of the invention, a relative movement between the sample and the detection or analysis system, respectively, is necessary, which relative movement may be continuous or step-wise. Preferably, the lateral movement shall be possible to be continuously constant, and the vertical movement shall be attained by step-wise shifting of the focussing plane.

The control unit of the arrangement according to the invention serves to coordinate and synchronize the illumination times and—if several wave lengths are used—to control the wave lengths, and also to coordinate the lateral or vertical relative movements between sample and detection and analysis system. Such control may, e.g., be effected by the CCD camera itself or by an arrangement comprising a pulse transmitter and a software for controlling the source(s) of light and the (relative) movement of the sample. In this instance, preferably, the control unit can also coordinate and synchronize the positioning and the shifting of the images to each sample position on the pixel array of the CCD camera and control and coordinate the readout and the evaluation of the pixel array images.

The arrangement according to the invention preferably comprises an epifluorescence microscope, in particular an epifluorescence microscope with a collecting efficiency of fluorescence quantums as electrons in pixels of the CCD camera of >3%, at a 40- to 100-fold magnification.

As the sample, the arrangement according to the invention preferably comprises a molecule library prepared by combinatorial chemistry.

It is more preferred that the sample comprises a multi-well plate or a micro (nano) titer plate.

Primarily if an epifluorescence microscope having a parallel beam region is used as source of light, preferably an galvano-optic mirror is provided in the parallel beam region, with which, e.g., an even faster data storage is enabled than is provided by the readout rate or frame transfer, respectively, of the CCD camera.

In the system according to the invention, “dyed” single molecules (e.g. fluorescence-labeled biomolecules) of a sample, in particular of a biological sample which is provided on a sample holding means, can be imaged on the pixel array of the CCD camera by the highly sensitive detection and analysis system, it being possible to continuously and constantly shift the sample and/or the detection and analysis system relative to each other. For such relative movement, the frame shift of the CCD camera may be used so that the signals (e.g. the fluorescence photons) of each single molecule, after conversion into electrons (“counts”) will be collected in the same pixels until the single molecule signal (number of “counts”) exceeds a certain minimum signal/noise ratio (which ensures the significance of the measurement).

With the arrangement according to the invention a decisive progress has been achieved over the afore-mentioned methods for detecting single molecules in artificial lipid membranes (Schmidt et al., Laser und Optoelektronik 29(1) (1997), pp. 56-62), in that the system used there can also be operated as HTS method with the arrangement of the invention, on account of the shifting procedure, and, therebeyond, can be simply used on complete biological cells. By enlarging the highly sensitive detection and analysis system with a scanning system, suprisingly, a constant single molecule sensitivity could be maintained in a simple manner (since each CCD camera in principle has a frame shift (the shifting and readout speed from line to line of the pixel array of the camera)), with a maximized throughput rate, and fluorophores on or in complete cells could be imaged within a very short period of time (approximately in 120 ms).

The high-resolution detection and analysis system according to the invention must be suitable for imaging the sample on the sample holding means insofar as it must have a pixel array image of the sample with a localization of individual molecules of at least 50 to 100 nm. To this end, according to the invention, a charged coupled device camera (CCD camera) is used which hitherto has already been particularly suitable in epifluorescence microscopy. With this, precisions of the localization of less than 30 nm can be attained without any problem.

When collecting the data, the lateral movement of the sample preferably should be carried out constantly and continuously, since an abrupt stopping or a high acceleration of the sample may cause the molecules to be detected in the sample, to additionally move, e.g. on or in the cells, which could lead to longer imaging times (on account of relaxation processes of the cell dynamics) by at least the 10-fold, which could also induce a cell response, and thus to a falsification of the biological processes to be observed. Usually, stepper motors are used for this, which ensure a smoothened mode of movement by a rapid sequence of movement steps. “Constant” and “continuous” within the scope of the present invention means that there is no extended stopping of the sample during the measurement process (or a measurement in the at-rest state, respectively), but that the sample (or the sample holding means, respectively) is always moved relative to the detection and analysis system.

Preferably, the movement of the sample is controlled directly by the detection and analysis system in the x-y direction, it being possible to adapt such controlling to the respective characteristics of the detection and analysis system. If a CCD camera is used in the detection and analysis system, the relative shifting can be triggered directly by the frame shift characteristic of the CCD camera. When a certain area on the sample holding means is illuminated, which area is being imaged on the entire pixel array used, the sample is continuously shifted, and, simultaneously, the image of the sample on the pixel array likewise is shifted line by line by continuous frame shift. In case of an optimum adaptation of the two speeds (relative velocity of the movement of the sample and frame shift (line readout speed) of the CCD camera), the information collected by a labeled molecule of the sample while traversing the illuminated region will be collected by practically the same pixels. Optimally, the speed with which the sample is moved will be equal to the speed of the CCD camera, divided by the magnification of the objective.

If, however, in addition to the x-y movement, also the image along the z direction is sampled, preferably a separate control unit, in particular a unit having its separate pulse transmitter and its separate software, is used.

According to the invention, mainly fluorescence dye is used as dye, i.e. visualization is carried out by using epifluorescence microscopy. According to the present state, the best resolutions can be attained by this method; it is, however, also conceivable to carry out the method of the invention with other processes (e.g. RAMAN, infrared, luminescence and enhanced RAMAN spectroscopy as well as radioactivity), similar resolutions as those of fluorescence technology in principle being attainable with luminescence or enhanced RAMAN, yet above all with bioluminescence.

According to the invention, the use of the two-photon excitation fluorescence microscopy (Sanchez et al., J. Phys. Chem. 101 (38) (1997), pp. 7020-7023) has proven particularly suitable, since with this method it is also possible to efficiently circumvent the problem of the autofluorescence of many cells.

Furthermore, this allows for a practically background-free measurement, which can also speed up HTS analysis. The two-photon excitation fluorescence spectroscopy (or, generally, multi-photon excitation (Yu et al., Bioimaging 4 (1996), pp. 198-207)) is particularly suitable for a three-dimensional illustration of samples, resulting in a further advantage, above all with cellular systems.

In the embodiment with fluorescence spectroscopy, the arrangement according to the invention preferably comprises one or several of the following components:

a laser as a precisely defined source of light, as well as

acousto-optical switches with high specificity, by which the laser beam may rapidly (e.g., 10-20 nsec) be interrupted for a defined period of time,

a processor which controls the switch, e.g. via a pulse program,

a dichroitic mirror (which, e.g., reflects the exciting light upwardly towards the sample and passes the fluorescent light from the sample downwardly (towards the analysis system),

a series of suitable filters known from conventional SDT arrangements,

a mobile sample holding means, e.g. a processor-controlled x-y drive (stepper motor),

a CCD camera by which the emitted light quantums which are passing the dichroitic mirror are converted into electrons and collected in pixels,

a galvano-optic mirror which directs the image onto pre-selected (in x direction) adjacently arranged areas of the pixel array, perpendicular to the frame shift direction (y direction),

a prism which divides the image into two spatially separated images with orthogonal polarization, and

a processor which controls movement of the sample (of the sample holding means) by an x-y drive (stepper motor), by the signals from the CCD camera being used via an internal clock to trigger the movement.

According to the invention, it is also possible to stoichiometrically label different types of molecules with a dye, preferably a fluorescence dye, e.g. a receptor and a ligand, and to pursue both with the arrangement of the invention.

It is also possible to label at least two different types of molecules with different fluorescence dyes and to subject them to SDT analysis, wherein, in addition to the respective single fluorescence, also additional information can be obtained by determining, e.g., the Förster transfer (Mahajan et al., Nature Biotech. 16, (1998), pp. 547-552). However, it ought to be substantially emphasized that with the Förster transfer alone merely a (although highly selective) qualitative, yet not a quantitative information is possible, since this effect is highly dependent on the distance of the fluorophores (with 1/r⁶).

If cellular systems are to be assayed according to the invention, it is preferably started with cells of low autofluorescence, there being various cell types which have little autofluorescence from the beginning (such as, e.g., mast cells or smooth muscle cells). Unfortunately, however, it is just the expression cells which, as a rule, are highly fluorescent, and therefore these or other cell types having intrinsic fluorescence must be provided in a low-fluorescent state by selected growing conditions or sample processing so that their autofluorescence will be brought to below a certain interfering level. When using two-photon excitation of fluorescence, this problem, however, does not occur from the very beginning, as has been mentioned before.

With the arrangement according to the invention, carrying out a visualizing method for single, e.g. biologically active, molecules is possible as a high throughput screening of biological units on the basis of the observation of single molecules (fluorophores).

High throughput screening (HTS) generally describes the search for certain “units” among a very large number of similar “units” (e.g. in a molecule library and a partial molecule library prepared by combinatorial chemistry). Such problems are encountered in many fields, both in basic bio-scientific research and also in the medically-pharmaceutically oriented industrial research and development. “Units”, according to the invention, may be biological cells, yet also individual molecules or types of molecules, high throughput screening e.g. being possible for detecting rarely occurring cells having a certain genetic defect. Besides its usefulness in connection with questions of cellular biology and pathology, high throughput screening is important in molecular biology. Thus, the arrangement according to the invention may, e.g., be used to find single DNA or c-DNA molecules in a sample comprising many DNA molecules. In biochemistry, the separation of macromolecules having certain properties, e.g. with respect to ligand binding or state of phosphorylation in or on cells, is a basic requirement which can be dealt with according to the invention. The pharmaceutical industry needs high throughput screening both for selecting certain active agents and also for analyzing their activity on biological cells. Each person skilled in the art will know what belongs to HTS methods or which materials can be used therefor (e.g. molecule libraries prepared by combinatorial chemistry or genomic-combinatorial libraries) (cf., e.g., “High Throughput Screening”, John P. Devlin (Ed.) Marcel Dekker Inc. (1997)).

For a specific labeling of certain “units”, according to the invention mostly the natural principles of the structurally-specific molecular recognition are employed, such as the binding of antibodies or, generally, of ligands to receptor molecules. The preferred use according to the invention of fluorescent ligands, such as antibodies with bound fluorescence molecules, allows for a both sensitive and selective detection of units with receptors for the fluorescence-labeled ligands. As an alternative to fluorescent ligands, fluorescent groups can be inserted in protein sequences and coexpressed (e.g. the “green fluorescence protein” (GFP) or variants thereof (“blue fluorescence protein”—BFP).

According to the invention, with the use of fluorescence, a high throughput screening with simultaneous ultimative sensitivity (i.e. clear detection of the fluorescence of individual fluorescence markers) and high throughput rate (i.e., at least 10⁶ (cellular) units per inch² per hour) can be realized. Chemical units (e.g. biological molecules, such as receptor agonists or antagonists) may be assayed without any problem with a throughput rate of at least 10¹⁰ or 10¹² units per hour per inch².

When using cells in a HTS method, primarily microtiter plates are suitable with which a medicament screening can be carried out on complete cells, e.g. by titrating the cells into the individual wells which contain the substances to be screened (cf. e.g. WO 98/08092). Also the use or measurement of bio-chips (Nature Biotech. 16 (1998), 981-983) is possible with the system according to the invention.

If substances are identified as pharmaceutical target substances and isolated with the HTS method of the invention, which are new or for which so far a pharmaceutical activity could not be demonstrated, the present invention, in a further aspect, relates to a method for preparing a pharmaceutical composition, which comprises mixing of the substance identified and isolated according to the invention with a pharmaceutically acceptable carrier.

According to the invention, a clear detection is considered to be given if the minimum signal/noise ratio determined for single molecules is more than 3, preferably between 10 and 40, in particular between 20 and 30. If the signal/noise ratio is below a value of approximately 2 to 3, interpretation of the information content of the measurement obtained may be a problem.

A specific variant of the method according to the invention is the combination with the flow cytometry technology, in which the cells are moved by a flow cytometer past the detection and analysis system. In the simplest instance, in a preferred variant of the arrangement of the invention, a flowthrough cell is provided with the sample holding means (or as the sample holding means itself, respectively).

As has already been mentioned, the arrangement according to the invention is particularly suitable for the analysis of samples which comprise biological cells, wherein particularly HTS methods may be carried out efficiently with the arrangement according to the invention. The spectrum of use of the arrangement of the invention is, however, also highly efficiently applicable to cell-free systems.

In the arrangement according to the invention, the relative shifting between sample and the highly sensitive (high-resolution) detection and analysis system preferably is controlled by the detection and analysis system itself, in particular by the CCD camera, if such relative shifting is to take place continuously, which is advantageous particularly in case of a lateral scan.

Since fluorescence analysis at present yields the best analyses, the arrangement according to the invention preferably comprises an EPI fluorescence microscope. Moreover, control of the continuous relative shifting can be triggered via the frame shift of the CCD camera, control being directly effected through the CCD camera, or in parallel by a synchronisation mechanism (e.g. location-correlated via photodiode triggering signals by using a co-transported punched tape, such as, e.g., described in Meyer et al., Biophys. J. 54 (1988), pp. 983-993).

A preferred embodiment of the present invention therefore is characterized in that the sample movement and the frame shift of the CCD camera are synchronized with each other by location-correlated signals derived from the continuous sample movement, preferably by using a punched tape moved together with the sample, and a fixed photodiode which transmits a signal when passing a punched hole.

In a further aspect, the present invention relates to a method for visualizing molecules, interactions between molecules, and molecular processes in a sample by using the SDT method employing an arrangement according to the invention.

Therefore, the present invention also relates to a method for visualizing molecules, their movement, molecule interactions, and molecular processes in a sample, wherein a sample in which certain molecules have been labeled with marker molecules are introduced into an arrangement according to the invention, the sample is imaged on a pixel array by the CCD camera, the sample and/or the detection and analysis system being shifted relative to each other by utilizing the frame shift of the CCD camera so that the signals of each single molecule in the sample will be collected in the same pixels after having been converted into electrons, until the single molecule signal exceeds a certain minimum signal/noise ratio.

Preferably, the relative movement of the sample is directly controlled according to the frame shift of the CCD camera, the relative movement of the sample being effected in lateral direction, preferably constantly and continuously.

In a further aspect, the present invention relates to a method for quasi-simultaneous imaging of fluorescence-labeled molecules in their distribution over complete biological cells (or biological systems, respectively) and for pursuing molecular movements and processes by repeating this imaging at temporal intervals by using the SDT method which is characterized in that a sample with cells, in which certain molecules have been labeled with marker molecules, are introduced into an arrangement according to the invention, the fluorescence image for a focussing plane is imaged on the pixel array of the CCD camera, the focussing plane is shifted step-wise along the z direction by a piezo-element, the fluorescence images to each plane being separately arranged on the pixel array, and after imaging of all the focussing planes, the image of the fluorescence labeled molecules in the cells is calculated, whereupon optionally the images of the focussing planes are repeated so as to illustrate molecular movements and processes by serially arranging images of all the focussing planes.

With this method, not only detection of single molecules on cell surfaces or in cells can be effected with the arrangement of the invention, but it is also possible to pursue the processes in (live) cells down to molecular movements and processes in terms of space and time. Thus it has become possible for the first time to image live cells in “real time” and thus observe molecular processes in and on these cells.

Of course, this method is not only usable for complete cells, but also for observing processes in all biological systems, such as, e.g., in isolated cell membranes or in synthetic cell compartments or synthetic membranes in which biological molecules are incorporated (according to the invention, all these systems are also encompassed by the term “biological cells”).

Preferably, imaging on the pixel array of the CCD camera, primarily in a 3D scan of the cells, is effected at a rate of from 1 to 3 ms per image and at a capacity of up to 300 images per array, with an image size of 80×80 pixels. Other adjustments can be further optimized by the skilled artisan for the respective CCD camera, source of light etc. used, in dependence on these individual components.

With the arrangements according to the invention and by means of the methods of the invention it is not only possible to use a single fluorescence marker, but the use of two or more fluorescence markers is possible without any problem. For instance, also the system described in U.S. Pat. No. 5,815,262 in principle can be employed according to the invention.

According to a preferred embodiment, the present invention also relates to a method in which at least two different types of molecules in the sample, in particular in the cell, are labeled by at least two different fluorescence markers, whereupon not only the movement of one molecule in the system, but also the relative movement of the different molecules in the system can be imaged and pursued in terms of time and space.

Preferably, the fluorescence image is captured for two orthogonal polarization directions for each fluorescence marker by dividing the image into two images with orthogonal polarization direction. This may be enabled by using a Wollaston prism and an imaging optic which has a parallel beam region, the Wollaston prism being used in the parallel beam region of the source of light.

In addition, also a galvano-optical rotating mirror may be used in the parallel beam region, e.g. of an epifluorescence microscope.

By using the rotating mirror and the Wollaston prism, in a 3D scan successive images of the focussing planes with both polarization parts can be stored separately adjacently on the entire width of the pixel array of the CCD camera. By means of frame shift, this image sequence can be shifted as a whole by one image width, whereupon the next image sequence will be stored by mirror rotation until either sufficient information has been gathered or the pixel array is full. Then the entire information can be read out for processing to a 3D image, and the camera will be free for the next 3D imaging.

In doing so, positioning and shifting of the images to each sample position on the pixel array of the CCD camera for different fluorescence phases and two polarization directions can be effected by the control unit by means of a pulse transmitter and corresponding software.

Preferably, cells of low intrinsic fluorescence are used in the sample.

Preferably, the method according to the invention is carried out as a high throughput analysis, wherein, e.g., a molecule library can be analyzed as the sample, preferably a molecule library prepared by combinatorial chemistry. According to the invention, also the interaction of an entire molecule library with biological cells can be analyzed.

The fields of application for the present invention are practically unlimited, preferred are, however, pharmacy (primarily HTS of new chemical units) as well as biochemical questions, since, due to the extremely high sensitivity of the methodology according to the invention (a single molecule can be pursued) and the exact localization (e.g. with a precision to at least 30 nm) basically each individual molecule or molecule associate, e.g. on or in cells, can be detected and identified (optionally also isolated). Thus, the bindings of all natural ligands to a cell (hormones, primary messenger substances, etc.) or cell-cell recognition molecules with molar binding can be analyzed, also as regards the exact binding kinetics and binding conformation, as well as regards the mobility of these components within the cell or within the cell membrane (analogous to Schmidt et al., J. Phys. Chem. 99 (1995), pp. 17662-17668 (for molecule position and mobility determinations); Schütz et al., Biophys. J. 73 (1997), pp. 1-8; Schmidt et al., Anal. Chem. 68 (1996), pp. 4397-4401 (for stoichiometric determinations); Schütz et al., Optics Lett. 22 (9), pp. 651-653 (as regards conformation changes).

Furthermore, the system according to the invention is particularly suitable for analyzing and identifying or isolating, respectively, (alternative) binding partners in receptor-ligand or virus-receptor systems, wherein also potential agonists/antagonists and their action (e.g. the competitive inhibition) can be precisely analyzed. This is particularly essential when finding new chemical units (NCU) in the field of medicament screenings.

When analyzing entire cells, the focus plane may be varied; in a rapid variant, a section through the cell (preferably, the upper cell half; “lower” meaning the side facing the sample holding means) is analyzed. Thus, it is also possible to analyze complex processes in a cell, such as nucleopore-transport, the effect of pharmaceuticals with a target in the cell or secondary reactions in the cell, on single molecule level.

According to a preferred embodiment, the system of the invention may also be used to analyze three-dimensionally (3D) occurring processes in single cells, such as cells which have been pre-selected in a first area scan according to the invention. In doing so, by a continuous or discrete shift of the focus plane along the z axis, in addition to the inventive mode of procedure (sample shifting with synchronized frame shift of the CCD camera), the three-dimensional arrangement of fluorescence-labeled molecules or associates on or in the cell can be imaged, in measurement times in the range of seconds or even therebelow, with a location resolution close to the diffraction limit. Compared to the hitherto only other method, the confocal scanning fluorescence microscopy, CSFM (Handbook of Biological Confocal Microscopy, ed. James B. Pawley, second edition (1995), Plenum Press, New York and London), the illustrated, above-indicated method according to the invention, firstly, is more rapid by at least a factor 1000, since simultaneously the information with equal resolution can be collected by at least 1000 focus areas, whereby, secondly, it is possible for the first time to image non-static molecules or associates, respectively, in spatial-temporal arrangement in periods of time (1 s, e.g.,) which are small enough to observe diffusion processes, energy-driven movements or metabolic processes.

In a preferred embodiment, thus, the focus plane of the detection and analysis system (in particular, of the epifluorescence microscope) can be shifted along the z direction (i.e., normal to the x-y plane which is defined by the sample surface (the sample holding means)), optionally in addition to the relative movement between sample and detection and analysis system.

In doing so, 3D imaging is carried out, preferably by imaging of discrete, consecutive focus planes in z direction, in rapid cyclical repetition, during a continuous relative movement between sample and CCD camera, by parallel collecting of the images of different z planes on the pixel array by using a galvano-optical mirror. Thus, substantial advantages of both imaging methods can be combined, which preferably is used for cellular HTS, yet also in general for molecular-mechanistic questions of cellular biology, physiology and pharmacology.

Preferably, the x-y scan and the 3D imaging can be effected simultaneously. To this end, the images of each z plane can be captured adjacently by using the galvano-optical rotating mirror. In the slow x-y scan, several z cycles are passed per illumination time of each fluorophore. By this combination, the x-y scan is slowed down, i.e. by the factor of the number of the z planes.

The method according to the invention and the arrangement according to the invention are also very suitable for detecting the specific binding of labeled nucleic acids on so-called arrays. In doing so, a plurality of different nucleic acids (e.g., cDNAs, ESTs, genomic sections with various mutations (SNPs)) are immobilized in uniform patterns on a surface (e.g. synthetic material or glass). These arrays are then incubated with the sample to be tested comprising fluorescence-labeled nucleic acid molecules, the molecules from the sample being capable of specifically hybridizing with their homologous counterparts. This can be repeated with various markers on the same sample. In the prior art, evaluation of the binding events hitherto frequently has been effected with scanners or imaging methods which have a relatively low resolution and sensitivity. Here, the system according to the invention offers clear advantages, since the enormous speed as well as the high spatial resolution of the SDT analysis according to the invention come as an addition to the ultimative sensitivity of the method of the invention. Thus, it is easily possible to adapt systems as described in WO 97/43611, e.g., with the system according to the invention and to analyze them according to the invention.

This is primarily advantageous if the concentration of the labeled nucleic acids of the sample is very low. Thus, e.g., mRNAs which are present in the cell in a very low copy number (low abundance mRNAs), reliably can be detected with a suitable array. Further applications of this specific aspect of the present invention relate to problems in which the amount of the nucleic acids of the sample is very low, such as in forensic trace analysis, or in an analysis of embryonic or stem cells.

Moreover, the method according to the invention is particularly suitable for detecting nucleic acids in the so-called in situ hybridization. In this instance, tissue slices are incubated with a labeled sample. The specific binding of these nucleic acids of the sample allows for a statement as to which mRNAs are expressed in which regions of the tissue section. Since these mRNAs to be detected often are present in very low copy numbers, a high sensitivity of the detection system as is provided by the method according to the invention is advantageous.

Analogous to in situ hybridization with nucleic acids, also biorecognitive molecules, such as antibodies, can be used as sample molecules, in which instance the epitopes (e.g., certain protein molecules) recognized by the antibodies can be detected with high sensitivity.

Likewise, the method of the invention can be used in the analysis of chromosomes. In doing so, chromosome preparations are prepared on a carrier, and these are incubated with a corresponding nucleic acid sample. Detection of a specific binding allows for a conclusion regarding the localization of individual genes on the chromosomes.

The invention will now be explained in more detail by way of the following Examples and drawing figures, without, however, being restricted thereto.

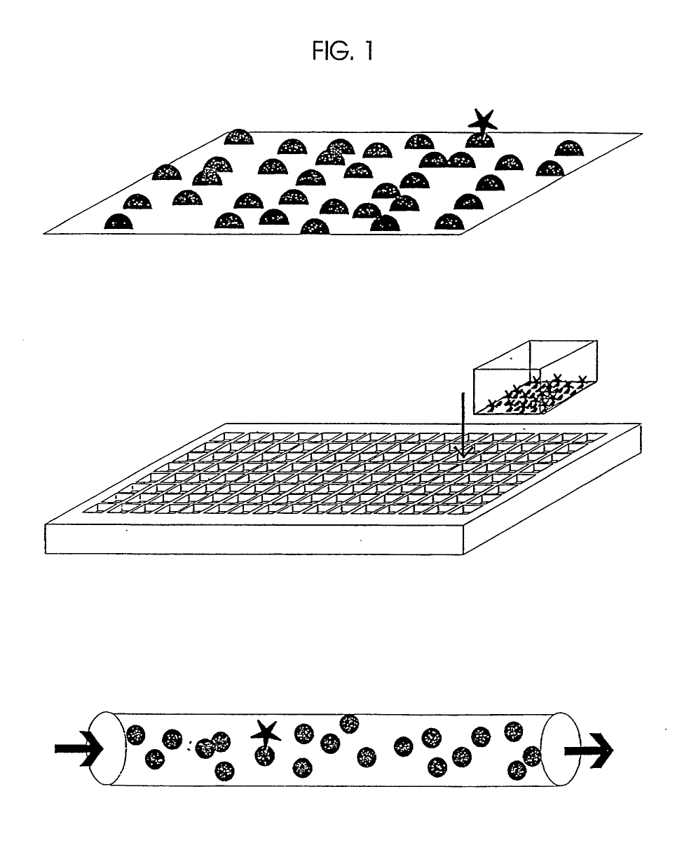

FIG. 1 shows the usual configurations of units for high throughput screening;

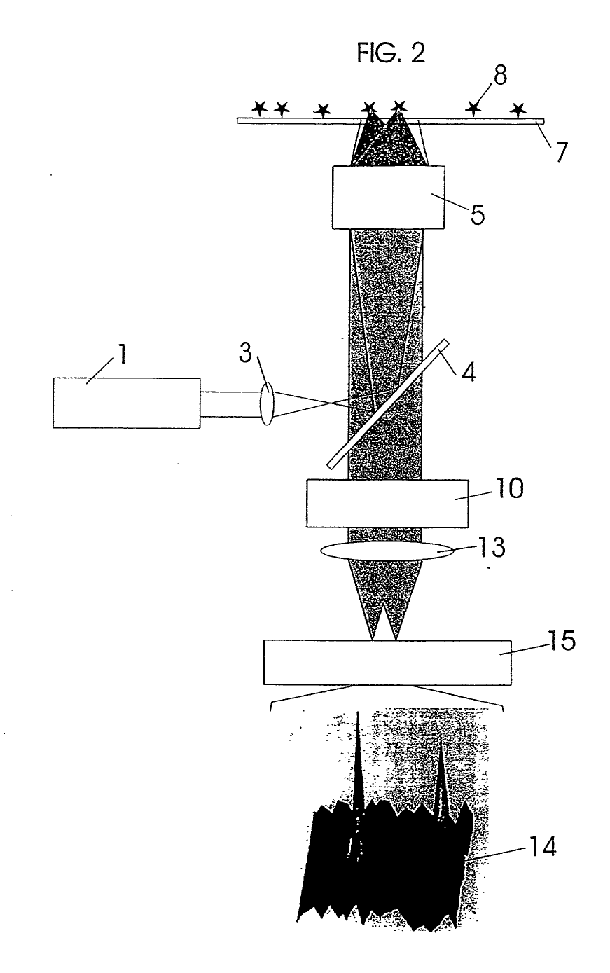

FIG. 2 shows one possible arrangement according to the invention;

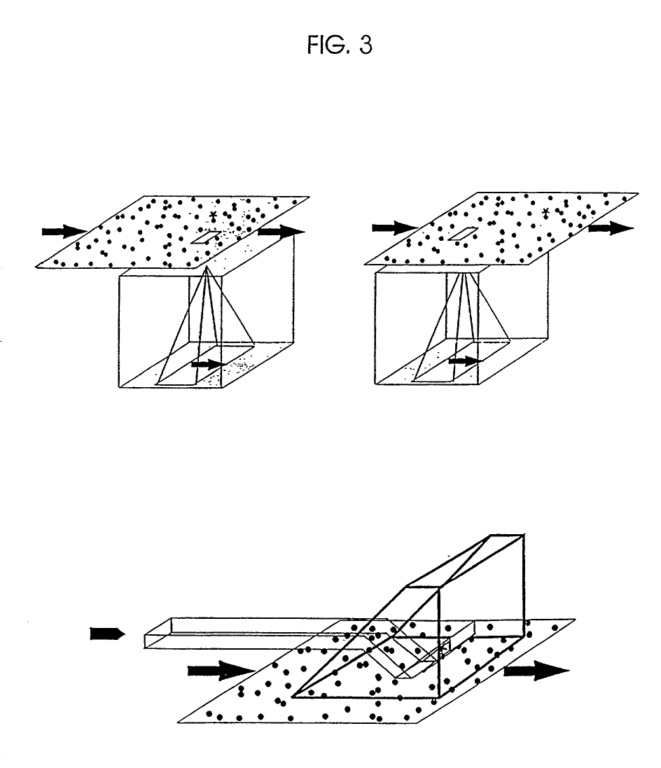

FIG. 3 shows the relative movement of the sample with frame shift;

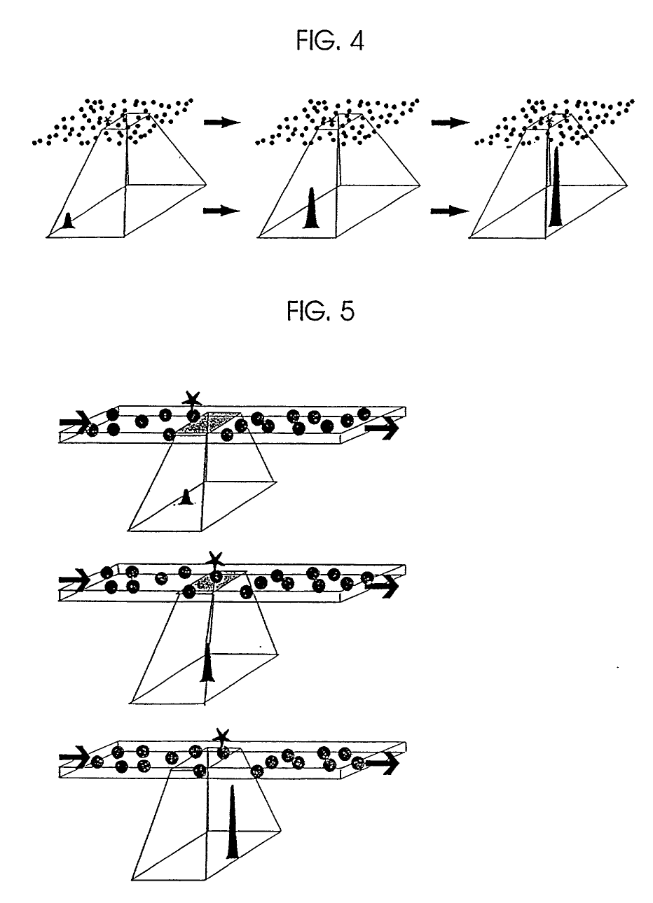

FIG. 4 shows the screening of units on surfaces or in multi-well plates;

FIG. 5 shows the screening in a laminar flow cell;

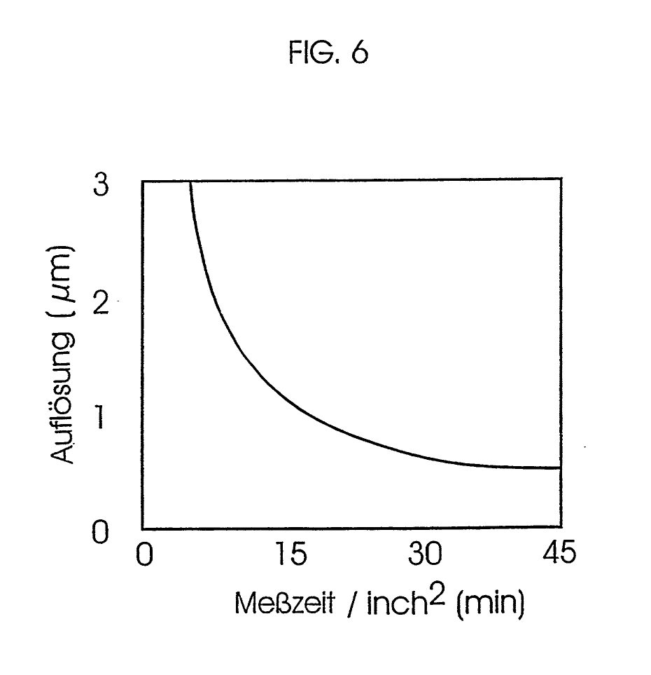

FIG. 6 shows the relation between screening time and resolution;

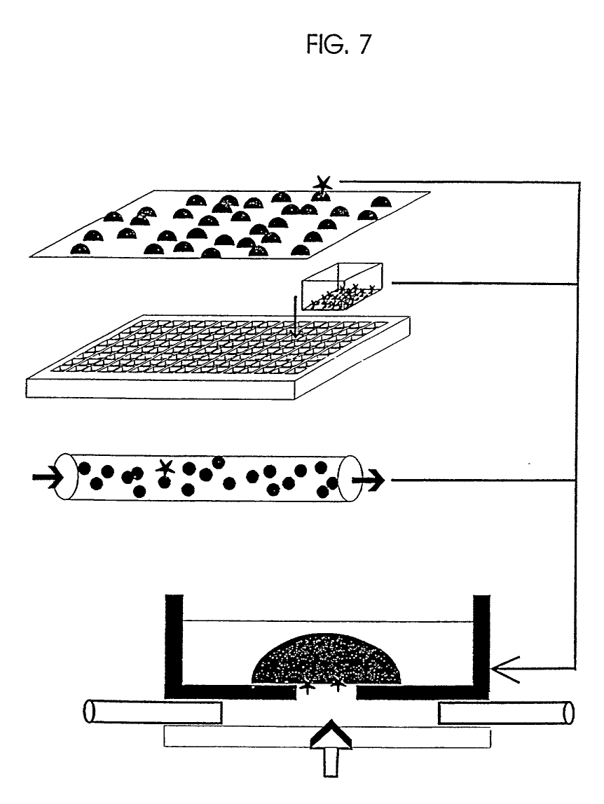

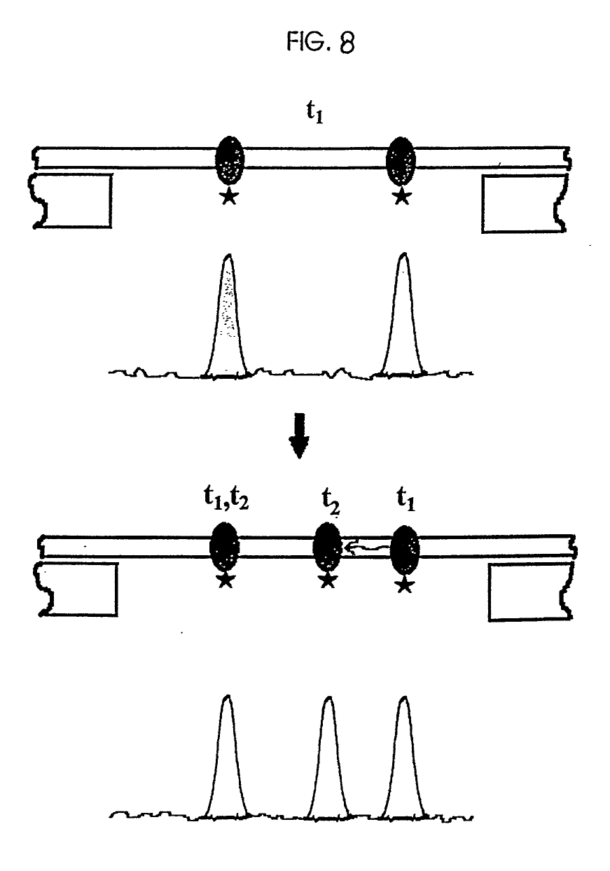

FIG. 7 shows the analysis of detected units;

FIG. 8 shows the positions of labeled molecules and the temporal tracing of molecule positions;

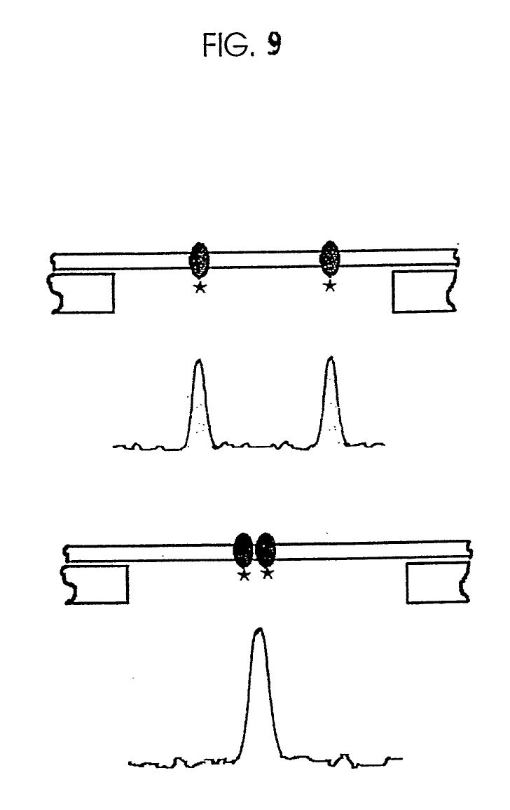

FIG. 9 shows the molecular association, co-localization, stoichiometry from signal quantization;

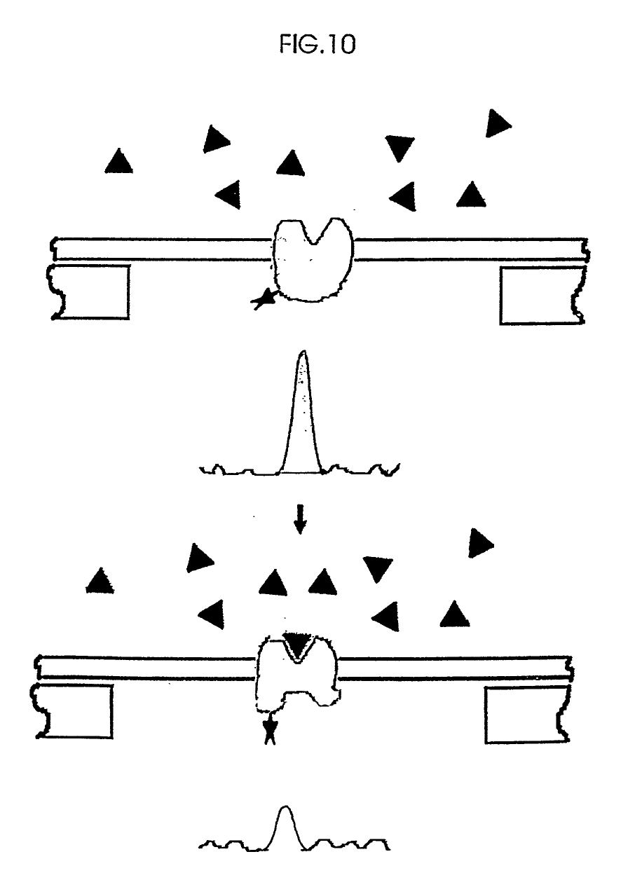

FIG. 10 shows the conformation change on the single molecule;

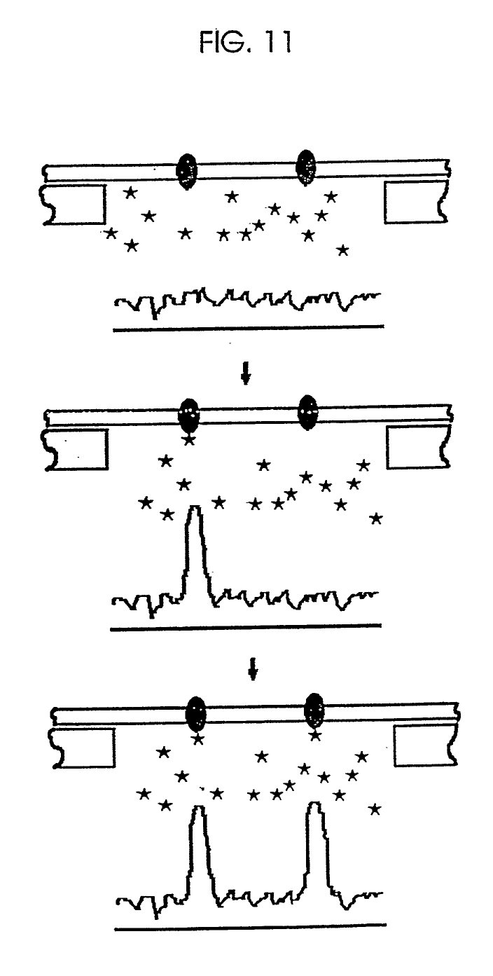

FIG. 11 shows the ligand binding;

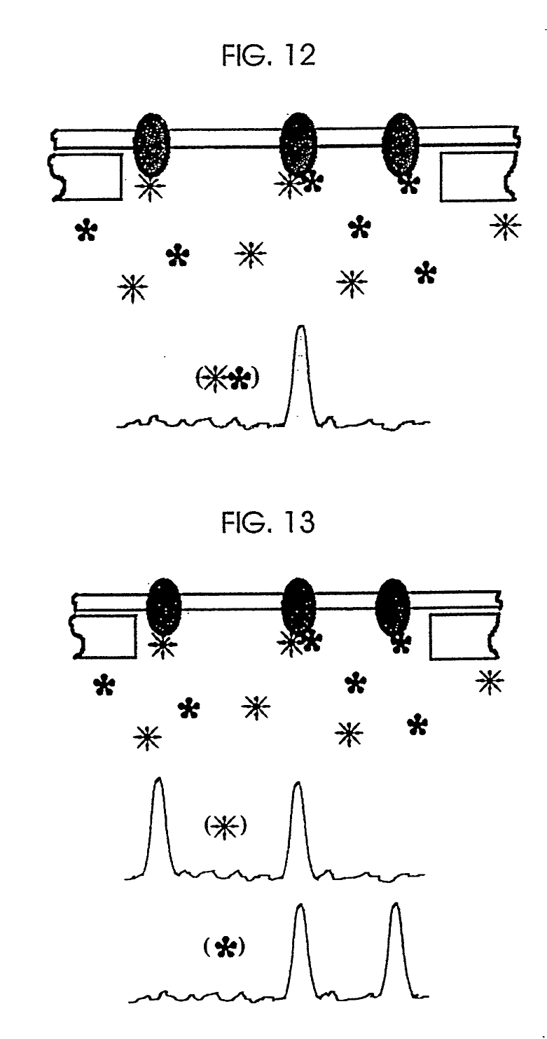

FIGS. 12-13 show the co-localization of two differently labeled ligands by energy transfer (FIG. 12), or by comparing the positions of the two dye molecules (FIG. 13);

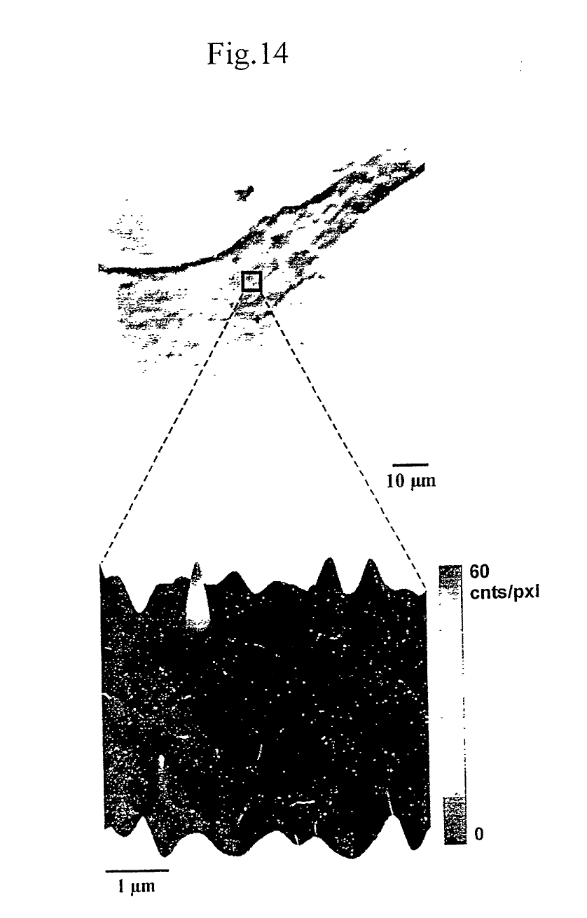

FIGS. 14-18 show the detection of individual lipid molecules in native cells;

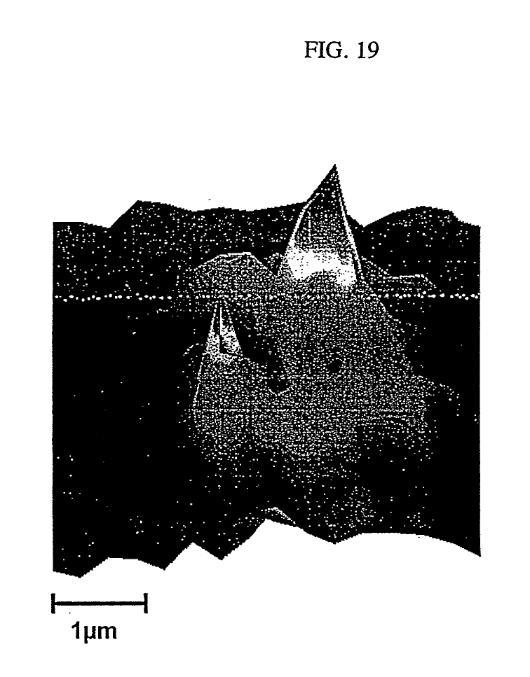

FIG. 19 shows the microscopy of individual lipid molecules with two-photon fluorescence excitation;

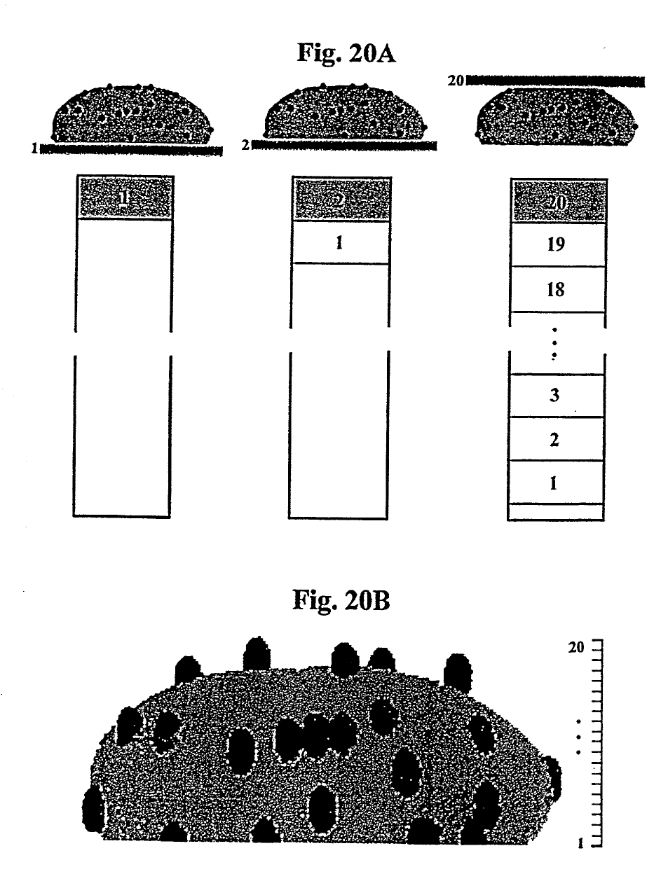

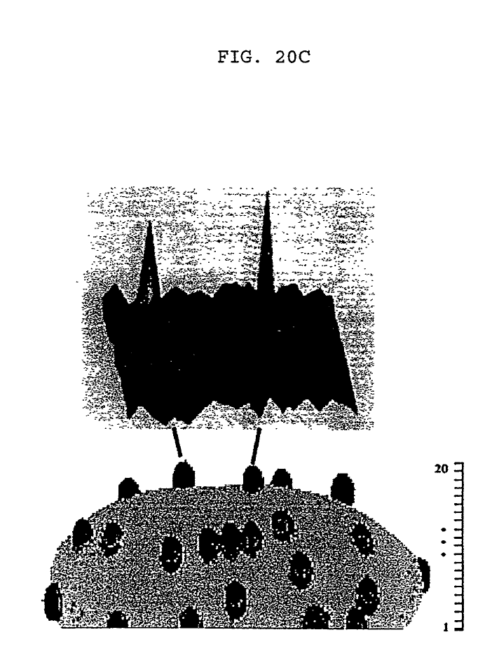

FIGS. 20A, B and C show the three-dimensional imaging of a selected single cell with single fluorophore resolution;

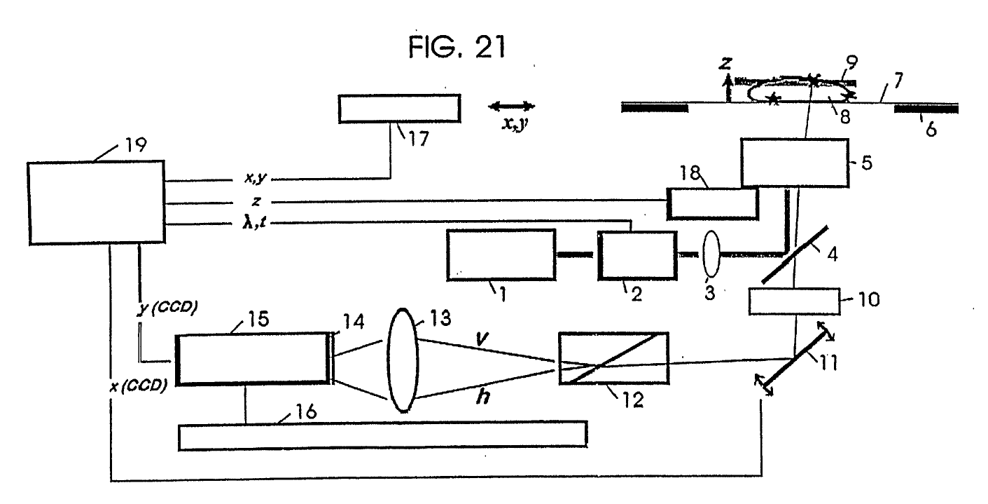

FIG. 21 shows an arrangement according to the invention, suitable for 3D-analysis of complete cells;

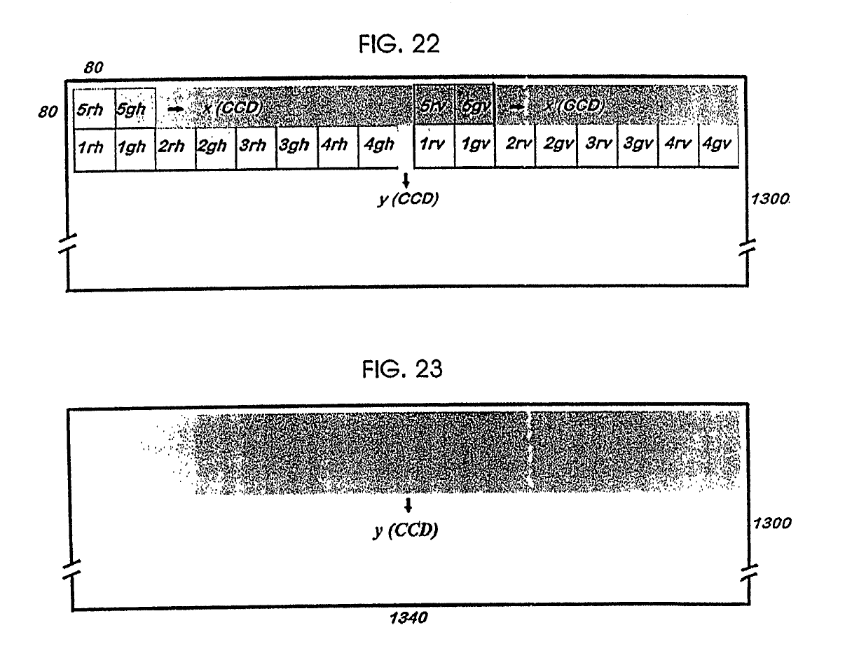

FIG. 22 shows the reading-in of the images in the pixel array of the CCD camera;

FIG. 23 shows the operating mode in large-area screening.

### EXAMPLES

### Example 1

### Arrangement According to the Invention, Employing Fluorescence Microscopy

Conventionally used configurations of units for high throughput screening (HTS) are illustrated in FIG. 1, which are all employed as measurement arrangements in the method according to the invention. Usual molecule libraries, prepared by combinatorial chemistry, are assembled on small (0.2 to 0.4 mm) polymer beads each carrying a single molecule species (cf., e.g., Devlin (1997), pp. 147-274). The measurement arrangement according to the embodiment described above starts from a conventional fluorescence microscope (FIG. 2) by means of which fluorophores (8) present on the substrate surface (7) in the illuminated area (˜100 μm²) could be individually detected and their movement could be followed, with a signal-to-noise ratio of ˜30 for single fluorophores (published in Proc. Natl. Acad. Sci., USA (1966) 93: 2926-2929). A Zeiss microscope (Axiovert 135-TV) having a ×100 objective (5) (Neofluar; numeric aperture=1.3, Zeiss) was used. For the fluorescence excitation, the laser light of the 514 nm line of an argon⁺ laser (1) (Innova 306, coherent), which was operated in TEM₀₀ mode, was coupled through an acousto-optical modulator (1205C-1; Isomet) in the epi-port of the microscope. A λ/4 plate delivered circular-polarized excitation light. By using a defocussing lens (3) (f=100 mm) in front of the dichroic mirror (515DRLEXT02; Omega), the Gaussian excitation profile was set to 6.1±0.8 μm full width at half maximum (FWHM) and 57±15 kW/cm² mean excitation intensity. The illumination time for each pixel array image was 5 ms. After long-pass filtering (10) (570DF70 Omega and OG550-3 Schott), the fluorescence was imaged by a lens (13) onto a liquid-nitrogen-cooled CCD camera (15) (AT200, 4 counts/pixel read-out noise; Photometrix), equipped with a TH512B chip (14) (512×512 pixel, 27 μm² pixel size; Tektronix). The point-transfer function of the microscope was described by a two-dimensional Gaussian intensity distribution with a width of 0.42 μm FWHM, as was found by determining images of 30 nm fluorescent beads (Molecular Probes). The diffraction-limited area thus was 0.14 μm². With 0.48±0.08 μm FWHM, the width of intensity profiles for single molecules was larger than the point-transfer function of the microscope, the additional broadening having been caused by molecular diffusion. The CCD was used as a memory means, with 12 consecutive images of 40×40 pixels being captured, wherein up to 140 pixel arrays could be imaged per second, due to CCD frame shift. This frame shift is used according to the invention for continuous movement of a sample holding means.

According to the present invention, this measurement principle can be applied to biological samples with fluorescent ligands in configurations as illustrated in FIG. 1. According to the apparatus by which the invention has been realized, sample screening is enabled which has a constant single fluorophore sensitivity with maximized throughput rate. The basic idea is once more explained in FIG. 3. At constant illumination of an area which is imaged on the total pixel array used, the sample is continuously shifted and, simultaneously, the image of the sample on the pixel array by continuous frame shift, line per line. With as precise a coordination of the two velocities (v (sample)=v(CCD)/magnification of the objective) as possible, the fluorescence collected from a fluorophore of the sample will be collected during traverse of the illuminated area by practically the same pixels.

In FIGS. 4 and 5, the cumulating image of a fluorophore up to reaching the read-out side of the pixel array is outlined for screening configurations according to FIG. 1. Optimization of the numerous apparatus variables and parameters is possible for the skilled artisan in analogy to the known methods; the ratio between resolution and measuring time is shown in FIG. 6: For typical characteristics of obtainable CCD cameras, sources of light and objectives, the measuring time for the screening of an area of 1 inch² was calculated, as a function of the resolution. Basically, there is a clear-cut region of the optimum relationship between measuring time and resolution, which in the example chosen is in the range of measuring times of from 15 to 30 min for 1 inch² (6.45 cm²) sample area, at a resolution of from 1-0.5 μm. The working point on this curve is adjusted by binning. To this end, the information of neighbouring pixels is combined (e.g. of b×b pixels), whereby the resolution decreases, at increasing maximum velocity v (frame shift) of the CCD camera and slightly increasing sensitivity. The latter is based on the fact that the noise merely is due to readout noise, and thus is equal in amount for the read-out of the counts in a single pixel as for the read-out of the counts in b×b pixels. The imaging quality of individual fluorophores thus is substantially maintained during screening (in the example according to FIG. 6, 250 counts per fluorophore are collected at 5 counts of read-out noise).

By the continuous sample movement, the waiting time is minimized which is necessary at discontinuous sample movement, due to the movement forming in the sample when the velocity is changed. Merely after termination of a line scan, the sample has to be returned and shifted by the width of the illuminated area, so as to collect the next line scan (in the example of FIG. 6, a waiting time of 1 s was allowed therefor).

The inventive combination of ultimative sensitivity and comparatively very rapid sample throughput opens up new fields of application. With a screening time of ˜15 min of a sample of typical size, a time range has been attained which allows for a screening under generally constant conditions of the samples. Samples with a correspondingly short life time can be assayed, and the detected units can be further used or analyzed. This, moreover, allows for the use of a wide range of fluorescence ligands with appropriately rapid dissociation rates (e.g., weakly binding antibodies). The simultaneous single fluorophore sensitivity basically enlarges the field of application to situations in which labeled sites per unit sought are to be expected in low numbers (down to a single site, such as when finding a mutation in a DNA sample).

According to the invention, the rapid and sensitive screening described can be further combined with a high selectivity and specificity. To this end, selective excitation of the fluorescence markers by two-photon absorption is used, whereby the fluorescence collected almost entirely comes merely from the thus-excited fluorescence markers in the focus area. In a further mode of action, two fluorescence-labeled ligands are used simultaneously, which both have neighbouring binding sites on the target structure. This may, e.g., be a natural ligand of a receptor merely occurring in the unit sought, together with an antibody which binds to the receptor molecule in the vicinity of the ligand. As outlined in FIG. 12, in case of a selective excitation of one of the two fluorophores (donor) and collection of the fluorescence (by appropriate optical filters) of only the second fluorophore (acceptor), merely the fluorescence formed by the transfer of energy from the donor to the acceptor will be detected. For this purpose, both fluorophores have to be in the immediate vicinity (distance≦8 nm). In this way, ligand pairs specifically bound to receptors become detectable individually and highly selectively (with still a high signal/noise ratio). Alternatively, separate images of both dyes can be made (with a time lag of merely 5 ms, cf. FIG. 13). Co-localized dye molecules (within the position precision of ˜50 nm) allow for a highly specific allocation, since here the quantum information of the single molecule intensities of two different fluorophores are retained as criterion, in contrast to the transfer of energy. Besides increasing the selectivity of fluorescence by transfer of energy, the specificity of the signal can be increased by illumination in total reflection (cf. FIG. 3 below). Thus, only those fluorophores are excited which are located in a range of approximately 100 nm from the substrate surface (exponentially fading light intensity). The detection sensitivity also reaches single fluorophores. This type of illumination shall complement the invention by enabling the use of high throughput screening for units (mainly cells) having a high autofluorescence.

According to the invention, immediately after the detection of sought units by screening, the same apparatus allows for a detailed analysis of these units. This may either be carried out directly in the screening sample, or after transfer of a unit into an analysis cell. FIG. 7 shows this on the example of a biological cell.

The analysis cell allows for single molecule microscopy in a region of the biological cell which is freely accessible to an exchangeable buffer solution and active substance. Furthermore, the cell is practically tightly bound electrically to the substrate so that the highly sensitive fluorescence microscopy can be combined with electrophysiology, e.g. for observing single ion channels, electrically and optically.

FIGS. 8-13 outline five basic types of information which become possible by single molecule microscopy on transferred units. In this connection, binning is employed to adapt the temporal and lateral resolution to the desired information. The sample is not moved, and short (ms), periodically repeated illumination is employed. This allows for each illumination to detect the positions of sufficiently far removed single fluorophores and to follow them temporally (FIG. 8). Thus it can be decided whether a labeled receptor is mobile, restricted mobile, or immobile, diffuses freely or has limited diffusion or is self-associated, co-associated with other components, or transiently clustered. Also the distribution over the (cell) surface can be made visible. The high signal and the high signal/noise ratio S/N (approximately 150 counts and S/N=30 for 5 ms of illumination) allows for the allocation of observed signals to the number of co-localized fluorophores. This opens the field for numerous mechanistic studies relating to the association, co-localization and stoichiometry of associated components, outlined in FIG. 9 for dimerization of a membrane component.

Special ligands (whose fluorophore points into a fixed direction after binding to the receptor) can be employed for single-molecular detection of conformational changes. A slight rotation of the fluorophore with a structural change of the receptor suffices to detect the conformational change via the intensity change of its fluorescence signal, as is outlined in FIG. 10. For this, both linearly polarized light of different directions of polarization and circularly polarized light are used.

For ligand concentrations of a few nM at the most, ligand binding can be analyzed on single-molecular level (FIG. 11), including the stoichiometry of the ligand binding, as well as allosteric and cooperative effects at ligand binding. By using two different fluorescence-labeled ligands, highly specific statements can be made with a high reliability that the ligands observed are bound to the receptor. For this, either energy transfer between the two fluorophores can be used (FIG. 12), or their co-localization in consecutive images for each of the two dyes. (FIG. 13).

The inventive continuous imaging of the fluorophores in the sample by synchronous movement of the sample and CCD frame shift (according to FIGS. 3 to 6) has neither been described nor suggested in the prior art relating to single fluorophore imaging, since there, only static images have been captured in immobile samples. With the system according to the invention, in addition to the ultimative optical resolution and sensitivity of the time-resolved detection of single molecules (e.g., receptors on cells), a considerable screening speed has become possible which is at least 1000 times more rapid than in the alternative methods of confocal microscopy, with simultaneous observation of an ensemble of molecules which is not possible by confocal microscopy.

### Example 2

### Detection of Fluorescence-Labeled Lipid Molecules in the Plasma Membrane of Native Smooth Muscle Cells

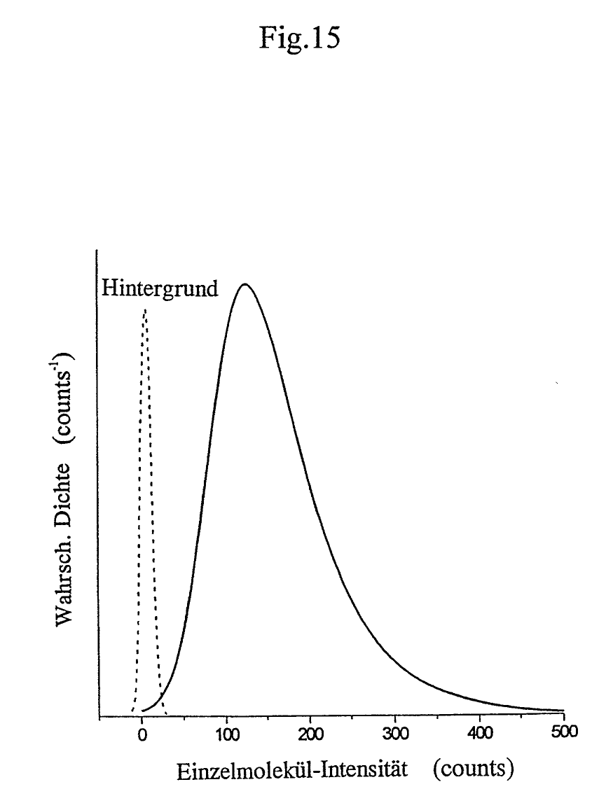

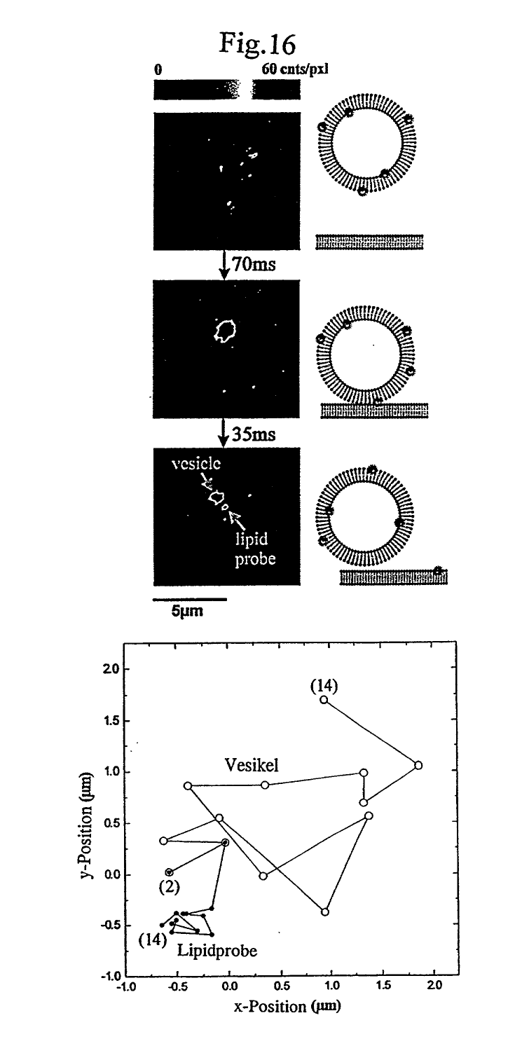

Methodology: smooth muscle cell, HASM: human aorta smooth muscle, stable cell line of wild type, are allowed to grow on a cover glass and subjected to microscopy in PBS buffer. Incorporation of DMPE-Cy5 (dimiristoyl-phosphatidyl-ethanolamine with Cy5 (from AMERSHAM) bound as dye molecule) is effected via lipid vesicle (POPC: palmitoyl-oleoyl-phosphatidylcholine, from AVANTI). Each 1000th lipid in the vesicles was a DMPE-Cy5 (mean: 5 DMPE-Cy5 per vesicle). Addition of these vesicles via the flowthrough cell to the HASM cells in the microscope (50 μg/ml vesicle, incubation for 10 min, then washed out with PBS buffer) leads to DMPE-Cy5 individually incorporated in the plasma membrane, via vesicle/cell membrane/lipid exchange. This process of the delivery of one DMPE-Cy5 to the plasma membrane is directly visible in FIG. 16, the vesicle (at ˜10 DMPE-Cy5, cf. high signal) quickly diffusing along the cell membrane and one DMPE-Cy5 suddenly changing over from the vesicle into the plasma membrane. The movements of the lipid sample and of the vesicle could be observed separately (cf. trajectories in FIG. 16, bottom). Such an exchange could not be observed previously on single molecule level. What is essential, however, is that the intensity of one fluorophore is still clearly resolved in the cell having autofluorescence (FIG. 14). In the present example (FIGS. 14-18), the intensity of the laser light (630 nm) was reduced such that the effective fluorescence background of the cell became less than the readout noise. The intensity may, however, be increased at any time, so that—via the intrinsic fluorescence of the cell—it is possible to get an orientation regarding the site at which the measurement is being carried out. The intensity distribution of 300 single molecules (FIG. 15) resulted in a signal/noise ratio of 25 for the detection of individual molecules in the native cell membrane, at 5 ms of illumination. For a better understanding of the peaks shown: The area shown comprises 576 pixels, and this corresponds to an object area of ˜6×6 μm (each pixel is 27×27 μm, a ×100 objective was used). The HASM cell has a length of approximately 100 μm, a width of 15-20 μm, and a height of 5-10 μm. The illustration is diffraction-limited, i.e. each dot source is imaged as a Gaussian spot having a radius of ˜270 nm, this corresponds to 1 pixel (60% of the peaks on 4 pixels). In the peak there were 152 cnts.

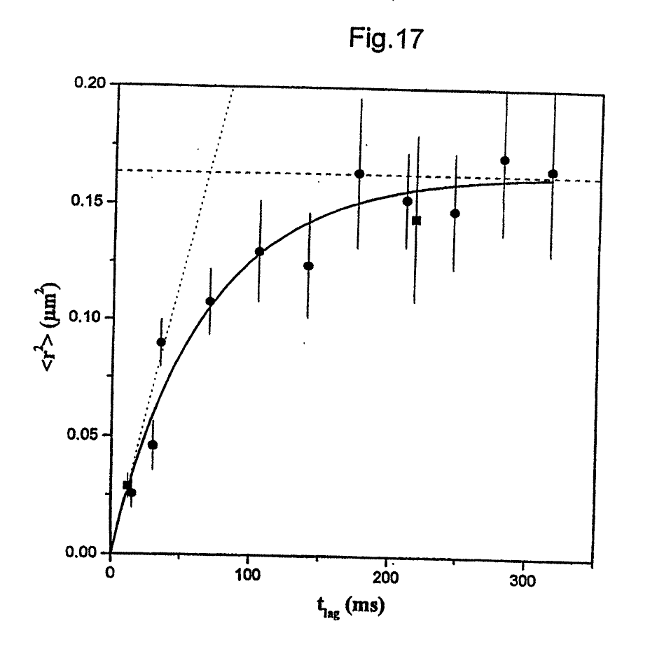

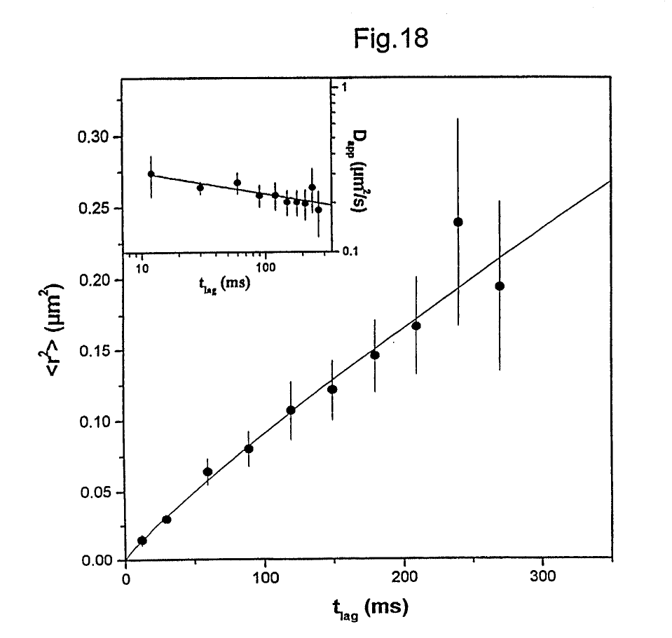

As a matter of routine, sequences of up to 14 images were captured (cf. FIG. 16), 5 ms illumination each, with dark intervals of between 10 to 30 ms (i.e. measuring times of up to ˜0.5 sec). These result in trajectories for the movement of the labeled lipids in the plasma membrane. ˜300 of such trajectories were evaluated (includes measurements on three different cells and on different locations of the cells, yet always on the upper side of the cells which are adhered on the bottom of the cover glass). In the measuring time of 0.5 sec, no convection or other cell movement was observed (except for a few erratic cell jerks). The result was impressive: The evaluation of the trajectories is illustrated in FIG. 17: The square of the distance (MSD=mean square displacement) between observed molecule positions and trajectories is entered against the respective time interval At. With Brown's diffusion processes, this should result in a linear connection; MSD=4Dₗₐₜ. Δt, with the diffusion constant Dₗₐₜ for lateral movement resulting from the ascent 4Dₗₐₜ. At first, for short diffusion lengths, a diffusion with Dₗₐₜ=0.6 μm²/sec appears, a typical value for lipid diffusion in cell membranes (from ensemble measurements via FRAP: fluorescence recovery after photobleaching). For longer diffusion periods, the range of movement of the lipid sample remains limited. The dashed line indicates that the sample in its movement remains restriced to an area having a radius of 300 nm. This is the first direct proof of the existence of lipid domains which hitherto have merely been postulated (“lipid rafts”, Simons and Ikonen, Nature 387: 569-572). For “lipid rafts”, the preferential partition of lipids with saturated acyl chains is postulated (as in the lipid sample DMPE-Cy5). In fact, the homologous sample DOPE-Cy5 which has only one double bond in each acyl chain, did not exhibit a partition in domains (proven by co-localization, not illustrated), but free, unrestricted diffusion in the plasma membrane (FIG. 18).

A further analysis of the domains showed that they are anchored on the cytoskeleton and move actively (uni-directional).

In principle, these results indicate that any application of SDT on cells, also as hitherto has been used on model systems, opens up new possibilities, simply due to the fact that processes can be viewed on a single-molecular basis and dynamically, which so far have been accessible merely via ensemble-mediated data. In this connection, the present proof is essential that single fluorophores on live cells (at least on these smooth muscle cells) can be viewed by microscopy clearly and with time resolution. The marker, Cy-5, may also be attached to a ligand having the same fluorescence properties. The frame-sample-shift reduces this resolution only unsubstantially, it serves for the continous screening of complete cell cultures or cells in nanotiter plates etc. Resolution can be further improved by two-photon-excitation fluorescence microscopy. FIG. 19 shows the first realization of a two-photon imaging of two phospholipids (PE-) with bound TMR (tetramethyl-rhodamine) as fluorescence markers in a phospholipid (POPC) membrane.

### Example 3

### Simulation of a Real Time Image of the Distribution of Single Fluorophores on Complete Cells, the Spatial-Temporal Resolution, the Position Precision and the Detection Safety of the Fluorophores

In Example 2, the observation of the single lipid diffusion in the plasma membrane of the cell i.a. was possible because the plane of the lipid movement (membrane surface) could be brought into register with the focus plane (layer with an effective thickness of 1.6 μm) to a sufficient extent, which was realized by focussing on the upper rim of the cell.

To capture movements in any direction, also transverse to the focus plane, at any location on or in the cell, as well as almost at the same time for all the fluorescence-labeled molecules, the sample movement according to the invention and frame shift is carried out in the following variant:

Methodology: The methodology and the arrangement for imaging is as in Example 2, with two substantial differences:

1.) For sequential imaging, the focus plane is moved through the cell step-wise from position to position in the z-direction. This is outlined in FIG. 20A, with the focus layer in red, (effective thickness from which fluorescence photons are collected is 1.6 μm), a cell in green (approximate height of 8 μm), with an ensemble of randomly distributed equal fluorophores (black dots).

2.) A CCD camera of the following specifications is being used: with large, elongate pixel array and particularly rapid frame shift (e.g. a CCD camera with 2048×256 pixels of a size of 20×20 μm, 7 μs shift time per line, and 2 μs/pixel readout time, conversion of 0.8 electrons/photon, as is offered for spectroscopy by PHOTOMETRICS, e.g.).

In the exemplary embodiment (FIG. 20), 20 images are captured while the focus layer passes through the entire cell. Each image is taken with the same illumination time “t(ill)” on the same partial area of the pixel array (gray area in FIG. 20A with 100×256 pixels), and then shifted by frame shift, as illustrated in FIG. 20A for the first, second and last image. During the time required for the frame shift (“t(fs)”, 0.7 ms with the above-specified camera, imaging is interrupted (by interrupting the illumination or covering the camera).

Shifting of the focus plane per image captured is chosen to be equal to 0.4 μm in the exemplary embodiment, so that the 20 images will just cover the entire cell of 8 μm height (cf. FIG. 20A). The time “t(ill)” is freely selectable within limits. On the one hand, “t(ill)” should be substantially longer than “t(fs)” to keep low the information loss due to the illumination pauses. On the other hand, the entire imaging time t(total)=(t(ill)+t(fs))×20 should not be too long (long “t(ill)”-times are advantageous to even out unspecific fluorescence) so that the molecule ensemble of the entire cell can nearly be imaged in real time. Real time imaging requires t(total)<t(mov), wherein “t(mov)” is the time which is required by the molecules imaged to move over a longitudinal extension which corresponds to the optical resolution (approximately 0.5 μm in x- and y-direction, and approximately 1.6 μm in z-direction). For diffusion of typical membrane proteins or of actively transported components, “t(mov)” is mostly below approximately 0.6 s. From this there results for the exemplary embodiment a range of 5 ms<t(ill)<30 ms for real time imaging of the fluorophores of a cell. The entire imaging will then take 0.1 s<t(total)<0.6 s.

FIG. 20B illustrates the calculated result of real time imaging of fluorophores on a cell membrane for t(ill)=5 ms, wherein the data and conditions measured in Example 2 were taken as a basis for single images (3 counts/pixel of autofluorescence of the cell, 152 counts/fluorophore for 5 ms illumination with an intensity averaged over the focus depth, lateral resolution of 0.5 μm, and focus depth of 1.6 μm). These data set all the parameters for calculating the 3D image for the above-described method, a rotation ellipsoid with random deviations being chosen as the cell form (FIG. 20A shows the front view of the cell), and with randomly distributed fluorophores on the cell membrane (black dots, total of 45). FIGS. 20B and C show the front view of the 3D fluorescence image of the cell and of the fluorophores, produced by complete simulation of the imaging method (in the simulation, each fluorophore emits fluorescence photons corresponding to the illumination at the moment, which are imaged in random distribution on corresponding pixels, taking into consideration the diffraction-limited imaging function of the microscope, after corresponding conversion to electrons as “counts”). The color code chosen shows green for a low count number (autofluorescence of the cell and readout noise), and yellow, light red to dark red for increasing number of counts. The color code is chosen such that the light red range approximately reproduces the resolution volume (due to the collection statistics slightly inexact ellipsoid with diameters of approximately 0.5 μm in the x-y plane and 1.6 μm in z-direction), and that the dark red core reflects the precision of the positioning of individual dyes (approximately 50 nm in the x-y plane and 150 nm in z-direction). The loss of data on account of dark periods during the frame shift could be approximately taken into consideration by interpolation between the intensities of consecutive images by the fact that in the mean, each fluorophore appears in 4 images (focus layer thickness=1.6 μm=4×dz, with dz=image-to-image shift=0.4 μm).

The simulation shows that 3D cell images in real time and with a clear detection of the fluorescence-labeled molecules are possible with the method according to the invention. In principle, this 3D image of the cell can be repeated several times after a minimum time each (“t(read)” which is necessary to read out the pixel arrays (approximately 1 s with the above-mentioned camera)). The number of repetitions is limited by bleaching of the fluorophores. For the conditions assumed in Example 2, at least a 3-fold repetition is possible without large losses by bleachout. In principle, the method cannot only image fluorophores on cells, as is illustrated in the exemplary embodiment, but also fluorophores in cells. To this end, the use of two-photon excitation may be advantageous, at least for studies in cells with high or not minimized autofluorescence.

Such real time 3D images of molecule ensembles of a cell do not only go far beyond the prior art, but in terms of quality they open up new ways for analysis of cyto-physiological processes, such as the uncovering and analysis of component organization/reorganization as an essential basis for the spatial-temporal regulation and coordination of cellular processes, or the mechanistic analysis of morphological responses of the cell to an external stimulus by, e.g., a messenger substance or by a pharmacologically active substance, or by a possible active substance identified according to the invention according to Example 1.

### Example 4

### Arrangement for 3D Imaging of Complete Cells

FIG. 21 is a representation of the SDT microscope according to the invention, with which in particular a 3D scan of complete biological cells may efficiently be carried out.

The source of light here consists of one or several lasers (argon laser, dye laser, two-photon excitation laser). The AOM (2) (acousto-optical modulator) allows the laser light to pass for adjustable times (controlled by the controller (19)) and certain colors, such as merely the light of the argon laser for certain exposure time, repeatedly after adjustable dark pauses, or alternatingly, laser light of different wave lengths (argon laser line, e.g., 514 nm, and 635 nm from the dye laser, which is pumped through the argon laser) to excite two different dye molecules in the sample.

The lens (3) widens the focus plane (9); it is exchangeable for illuminating 20 μm to 600 μm areas. For large exposure surfaces (in SDT-x,y-scan mode), the light is guided through a single mode-fiber optic bundle between AOM (2) and lens (3), so that homogenous illumination of round or rectangular regions (SDT-x,y-scan) is attained (not included in the Figure). The focus plane (9) is adjusted to a certain z-value (distance between focus plane and sample carrier surface (7)) by means of a z-Piezo (18) which shifts the objective (5) in z-direction.

The sample is horizontally shiftable (in x,y-plane) by precision motors (17) which shift the sample stage (6) and are controlled by the controller (19). In this connection, the z-piezo (18) may be used for secondary regulation of a constant z-value (via capacitative distance measurement, not included in the Figure).

The fluorescence of individual dye molecules may be detected on the pixel array (14) of the CCD camera (15) as a localized and clearly resolvable signal. At first, the fluorescence of a molecule is refracted by the objective into parallel beams (in the meantime state of the art for objectives of all fluorescence microscopes) of a certain angle. The bundle of beams passes the dichroitic mirror (4) which merely reflects the excitation light, as well as filters (10) which are merely transparent for the fluorscence light.

The next element in the beam path is a galvanometer-mirror (11). The mirror can be adjusted to any angle (necessary region approximately +/−5 degrees, corresponds to the width of the CCD camera indicated below by way of example) by the controller (19), with a precision of a few μrad and an adjustment time of approximately 0.3 ms (obtainable at Cambridge Technology, Inc. MA, USA, model 6800).

The thus deflected bundle of beams traverses a Wollaston prism (12) which resolves the fluorescence light into two beams of orthogonal polarization (h: horizontally, and v: vertically polarized). The angle between the two rays is adjustable by the shape of the prism and here is chosen such that after having passed the imaging lens (13), the two polarization portions of the fluorescence light are imaged simultaneously but spatially separated on the pixel array, at the distance of half the x-width of the array. Such prisms are offered by a few companies, e.g. by Bernhard Halle Nachf. GmbH & Co., Berlin.

The combination of galvanometer mirror (11) and Wollaston prism (12) allows for an optimum utilization of the memory area of the pixel array, in synchronism with the frame transfer of the CCD camera for data shifting in the y-direction of the array. The utilization of this memory and data shift possibilities depends on the application thereof. Applications can be subdivided into three groups: either the focus plane is horizontally (in the x,y-plane) moved through the sample (SDT-x,y-scan), or vertically (3D-SDT), or both, horizontally (slowly) and vertically (rapidly and in cycles). These three modes of utilization of the same apparatus differ from each other only by their controller program, i.e. the control of the sample movement (in x,y-direction or (and) in z-direction), in synchronism with the mode of illumination (wave lengths, light/dark intervals, etc.) and coordinated with suitable modes of data storage and shifting on the CCD pixel array (combined use of rotating mirror, Wollaston prism, frame transfer options and readout of the CCD camera).

Finally, the data collected with the CCD camera are processed, analyzed, and brought to be imaged by suitable means in an image generating unit (16).

The CCD camera which had been used for the estimates in FIG. 6 and FIGS. 22, 23 plus description (see below) is obtainable at Princeton Instruments, USA, model MicroMAX-1300PB.

In the working mode for large-area screening (SDT-x,y-scan), the sample is continuously moved by precision motors (17) in x-direction (cf. FIGS. 21 and 23). Illumination is large-area (approximately 100×250 μm) and continuous, so that each molecule will be illuminated for the same amount of time. At this mode, the rotating mirror remains in fixed angular position. The Wollaston prism may be used or pivoted out. The blind data on the CCD camera (cf. gray region in FIG. 23) are continuously shifted line by line in y-direction and read-out.

In the working mode for 3D imaging (real time 3D SDT) (cf. FIGS. 14-18), individual fluorescence markers on live cells can be imaged and their movement followed.

In FIG. 20, the principle of 3D imaging is illustrated, whereas FIG. 21 with FIG. 22 show the signal-logistic side of realization of the 3D imaging in terms of apparatus, yet also merely for one example (two colors with two polarizations each for each focus plane). Other applications, e.g. excitation of three or even more dyes, with or without polarization splitting, can be realized by modifying the control program analogous to the one described. Real time imaging of cells, according to the criterion indicated below, for up to four colors and registration of both polarization portions are feasible without any problems.

As the CCD camera, in the present Example a MicroMAX-1300 PB with 1300×1340 pixels is used. The pixel area is 20 μm×20 μm. The frame shift is in y-direction and requires 3 μs per line. Impacting photons are converted into electrons by a conversion of 0.9 in the entire optical range. For imaging times of seconds, the camera is practically free from spontaneously forming dark counts. Merely at a readout of the camera with 1 μs (20 μs) per pixel, a weak background noise of 7 electrons per pixel forms. As has been shown for the HASM cell, approximately 150 electrons can be collected from individual fluorophores in an illumination time of merely 5 ms, which can be repeated a few times (3-20 times with the presently common dye molecules). When illuminating a 16 μm measurement area, the image size is approximately 80×80 pixels for a 100-objective. FIG. 22 shows the taking of 4 images for each z-position of the focus plane. The number in the single images gives the focus plane, rising from z=0 by 0.5 μm each.

The second index, r or g, stands for red or green fluorescence. On the first focus plane, at first red fluorescence is excited, which then is divided into both polarization portions (h and v), and in the left or right half, respectively, of the array, is collected in separate single images during the illumination time (cf. 1rh and 1rv). Subsequently, green fluorescence is excited and collected in the image areas 1gh and 1gv. To this end, the rotating mirror is rotated into the next position (approximately by 0.5 degrees) in the dark pauses of 0.5 ms each, so that both the “1gh” and the “1gv” image, shifted by 80 pixels towards x, fall onto the image region (gray), directly adjacent the two “red” images of level 1. In the following 0.5 ms dark pause, the focus level 2 is adjusted (by controlling the z-piezo on the objective), and the rotating mirror is turned into its new position, for the following imaging of 2rh and 2rv at first, and, after a mirror rotation, of 2gh and 2gv on this focus level 2. This is continued until the image sequence (gray region) has been filled, in the present Example after the four imagings on level 4. In the subsequent pause of 0.5 ms, the 16 images are shifted by frame shift of the CCD camera in y-direction and 80 pixel lines, for which approximately 0.24 ms will be required, and the rotating mirror is moved back to its starting position. The image line marked in gray then is filled with further 16 images, from the focus planes 5 to 8, etc. When a predetermined z-value has been reached (exceeding the height of the imaged cell, approximately after 10 μm, corresponding to 20 imaging planes), the 3D image is finished.

With an illumination time of 1.5 ms for each h and v image pair, each dye molecule, because of the overlap of the 1.6 μm deep focus plane, is effectively illuminated for approximately 5 ms, and its partial images in neighbouring planes contain approximately 150 electrons in the image pair.

The total image (20 planes) then merely requires 80 ms. During this time, membrane molecules (diffusion constants <0.1 nm²/s) or actively moved molecules (velocity <2 μm/s) have not moved out of the optical resolution volume (ellipsoid with a length of half axis of 0.25 μm in x- and y-direction and 0.8 μm in z-direction). On the basis of this criterion, the method according to the invention allows for producing 3D images of a complete cell in real time, and this with single molecule sensitivity, for molecular detection over the entire cell, a goal not reached before.

The read-out time of this 3D information requires approximately 1 second. Thus, every second a new 3D image can be captured, or at longer time intervals desired. In this manner, movements and processes of single molecules or associates of the entire molecule ensemble imaged can be observed (as long as the molecules are still fluorescent; under the illumination conditions indicated, at least 3 3D images can be made with the fluorophores presently common), yet also with a smaller and slower camera good results can be obtained for one dye and without polarization splitting.

1. An arrangement for visualizing molecules, movements thereof, and interactions between molecules, and molecular processes in a sample, in particular molecules and processes in biological cells, by using the single dye tracing (SDT) method, comprising
at least one source of light for large-area fluorescence excitation via single or multi-photon absorption by equal or different marker molecules to molecules in the sample,
a sample holding means for accommodating the sample,
a highly-sensitive detection and analysis system comprising a charged coupled device (CCD) camera, the sample or the sample holding means, respectively, and/or the detection and analysis system being shiftable relative to each other during the measuring process, and
a control unit for coordinating and synchronizing illumination times and, optionally, wave lengths of the lateral or vertical movement of the sample or of the sample holding means, respectively, with the sample as well as, optionally, the positioning and shifting of the images of each sample position of the pixel array of the CCD camera.

2. An arrangement according to claim 1, characterized in that at least one source of light is a laser, in particular an acousto-optically switchable laser light.

3. An arrangement according to claim 1 or 2, characterized in that the source of light is an argon laser, a dye laser and/or a two-photon fluorescence excitation laser.

4. An arrangement according to any one of claims 1 to 3, characterized in that the control unit comprises a pulse transmitter and a software for controlling the source(s) of light and the movement of the sample.

5. An arrangement according to any one of claims 1 to 4, characterized in that the CCD camera comprises a frame shift mode and a continuous readout mode.

6. An arrangement according to any one of claims 1 to 5, characterized in that it comprises an epifluorescence microscope, preferably with a collecting efficiency of fluorescence quantums of >3%, at 40- to 100-fold magnification.

7. An arrangement according to any one of claims 1 to 6, characterized in that the CCD camera
is N₂-cooled,
comprises a large pixel array, in particular a pixel array ≧1340×1300,
comprises a conversion of photons into electrons of from 0.8 to 0.9 in the optical range,
has a readout noise of only a few electrons per pixel at 1 μs/pixel readout speed,
comprises <<1 dark counts/pixel×s, and/or
comprises a line shift rate of >3×10⁵/s.

8. An arrangement according to any one of claims 1 to 7, characterized in that the sample comprises a molecule library prepared by combinatorial chemistry.

9. An arrangement according to any one of claims 1 to 8, characterized in that the sample comprises a multi-well plate or a micro (nano) titer plate.

10. An arrangement according to any one of claims 1 to 9, characterized in that the sample carrying means is a flowthrough cell.

11. An arrangement according to any one of claims 1 to 10, characterized in that the focussing plane of the detection and analysis system is shiftable step-wise along the z-direction by a piezo element.

12. An arrangement according to any one of claims 1 to 11, characterized in that it comprises an epifluorescence microscope with a parallel beam region as the light source, which includes a galvano-optical mirror in the parallel beam region.

13. A method for visualizing molecules, movements thereof, and interactions between molecules, and molecular processes in a sample, in particular molecules and processes in biological cells, by using the single dye tracing (SDT) method, characterized in that a sample in which certain molecules have been labeled with marker molecules is introduced into an arrangement according to any one of claims 1 to 12, that the sample is imaged by the CCD camera on a pixel array, wherein the sample and/or the detection and analysis system are shifted relative to each other by using the frame shift of the CCD camera, so that the signals of each individual molecule in the sample are collected in the same pixels after conversion into electrons until the single molecule signal exceeds a certain minimum signal/noise ratio.

14. A method according to claim 13, characterized in that the relative movement of the sample is controlled corresponding to the frame shift of the CCD camera.

15. A method according to claim 13 or 14, characterized in that the relative movement of the sample in lateral direction is constant and continuous.

16. A method for quasi-simultaneous imaging of fluorescence-labeled molecules in their distribution over entire biological cells and for observing molecular movements and processes by repeating this imaging at temporal intervals by using the SDT method, characterized in that a sample in which certain molecules have been labeled with marker molecules is introduced into an arrangement according to any one of claims 1 to 12, the fluorescence image for one focussing plane is imaged on the pixel array of the CCD camera, the focussing plane is shifted step-wise along the z-direction by a piezo element, wherein the fluorescence images for each plane are separately arranged on the pixel array, and after imaging of all the focussing planes, the image of the fluorescence-labeled molecules in the cells is calculated, whereupon, optionally, imaging of the focussing planes is repeated so as to trace molecular movements and processes by consecutively arranging images of all the focussing planes.

17. A method according to any one of claims 13 to 16, characterized in that the images on the pixel array of the CCD camera are captured at a rate of from 1 to 3 ms per image and with a capacity of up to 300 images per array, with an image size of 80×80 pixels.

18. A method according to any one of claims 13 to 17, characterized in that at least two different types of molecules in the sample are labelled with at least two different fluorescence markers.

19. A method according to any one of claims 13 to 18, characterized in that the fluorescence imaging is effected for two orthogonal polarization directions for each fluorescence marker, preferably by dividing the image into two images with orthogonal polarization direction, by using a Wollaston prism and a source of light which comprises a parallel beam region, wherein the Wollaston prism is used in the parallel beam region of the source of light.

20. A method according to any one of claims 13 to 19, characterized in that the sample comprises cells with low autofluorescence.

21. A method according to any one of claims 13 to 20, characterized in that the method is carried out as a high throughput analysis.

22. A method according to any one of claims 13 to 21, characterized in that as the sample, a molecule library is analyzed, preferably a molecule library prepared by combinatorial chemistry.

23. A method according to any one of claims 13 to 22, characterized in that the interaction of a molecule library with biological cells is analyzed.
